(19) United States
(12) Patent Application Publication
(10) Pub. No.: US 2010/0114672 A1
(43) Pub. Date: May 6, 2010

(54) Employee Talent Review Management Module

(75) Inventors: Kenneth Klaus, Dublin, CA (US); Amy Wilson, Oakland, CA (US); Mary E. G. Bear, Burlingame, CA (US); Chau Ha Leung, Castro Valley, CA (US); Marcelyn Van Houten, Walnut Creek, CA (US); Chun-Yi Chen, Belmont, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/265,059

(22) Filed: Nov. 5, 2008

(51) Int. Cl. G06Q 10/00; G06Q 90/00

(52) U.S. Cl. 705/11

(57) ABSTRACT

Systems for reviewing talent of a number of employees of an organization are described herein. In one of several embodiments, a talent review module comprises a mechanism for gathering information from one or more sources within an organization. In particular, the information is related to talent characteristics of one or more employees of the organization. The talent review module in this embodiment also include a mechanism for graphically displaying one or more of the talent characteristics of the one or more employees.

### TECHNICAL FIELD

The embodiments of the present disclosure generally relate to enabling a user to review and modify information related to the performance and potential attributes of a number of employees of an organization.

### BACKGROUND

Most organizations have some type of system for evaluating the performance or potential attributes of their employees to determine their value to the organization. Certain performance expectations and goals are often established for particular jobs or roles and can sometimes be developed for individual employees. Some goals may be easy to quantify while others may be subjective to a supervisor's views. In any case, it is usually beneficial that the employees of an organization understand their specific duties, roles, expectations, etc. It is also beneficial that employees understand how their performance measures up to these expectations and how their performance compares with the performance of other employees that have similar jobs.

For many organizations, periodic reviews are conducted to communicate an evaluation of an employee's performance and potential over the course of a certain period of time. In this way, the employee's manager or supervisor can determine the effectiveness of the employee, evaluate their potential, set goals, and provide compensation. Also, management can use a collection of employee evaluations to address promotion and retention issues for meeting the organization's goals.

### SUMMARY

Embodiments of software applications for managing the talent within an organization are described in the present disclosure. In one of several embodiments, a talent review module comprises a mechanism for gathering information from one or more source applications within an organization. Particularly, the gathered information relates to talent characteristics of one or more employees of the organization. The talent review module further includes a mechanism for graphically displaying one or more of the talent characteristics of the one or more employees.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure and are not necessarily drawn to scale. Reference characters designating corresponding components are repeated as necessary throughout the figures for the sake of consistency and clarity.

FIG. 1 is a block diagram illustrating a computer system according to one embodiment.

FIG. 2 is a block diagram illustrating the talent review module shown in FIG. 1 according to one embodiment.

FIG. 3 is a diagram illustrating a user interface associated with the talent review module shown in FIG. 1, according to one embodiment.

FIG. 4 is a diagram illustrating another user interface associated with the talent review module shown in FIG. 1, according to one embodiment.

FIG. 5 is a diagram illustrating another user interface associated with the talent review module shown in FIG. 1, according to one embodiment.

FIG. 6 is a diagram illustrating another user interface associated with the talent review module shown in FIG. 1, according to one embodiment.

FIG. 7 is a diagram illustrating another user interface associated with the talent review module shown in FIG. 1, according to one embodiment.

### DETAILED DESCRIPTION

Employee reviews are commonly performed to determine the employee's value to an organization. These reviews are usually based on the manager's assessment of the employee's performance, potential, goals, and development plans in relation to both the organization's needs and the performance and potential of others in the organization—the combination of these attributes referred to herein as “talent.” Managing various pieces of talent information used to evaluate an employee's performance and potential can be a challenge. Often, this information is simply recorded on paper documents. However, according to the embodiments of the present disclosure, many aspects regarding an employee's performance and potential can be retrieved electronically from various memory sources and aggregated into one application. Having a greater accumulation of information allows the reviewers to more effectively evaluate employees, compare individual employees with other employees, compare groups of employees with other groups, make more informed decisions about promotions, potential, compensation, etc.

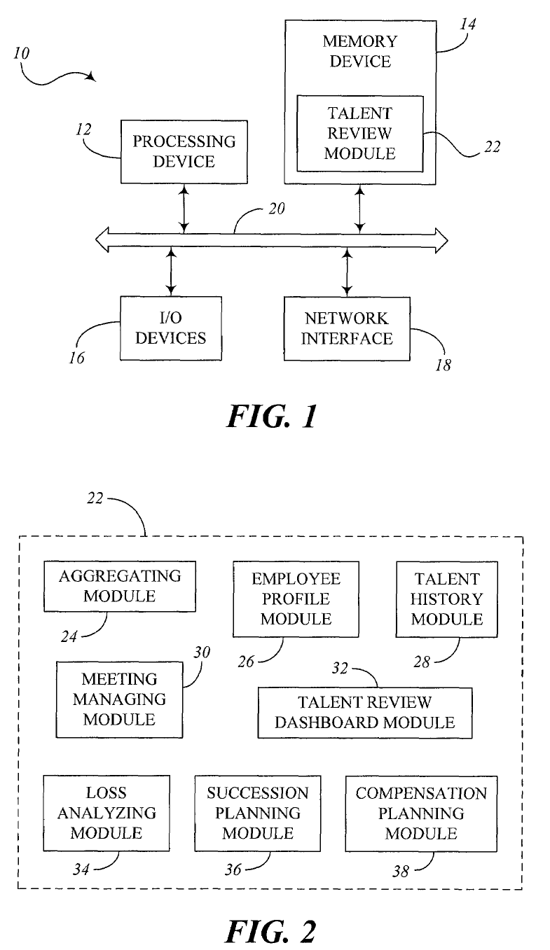

FIG. 1 is a block diagram of an embodiment of a computer system 10. In this embodiment, computer system 10 includes a processing device 12, a memory device 14, input/output (I/O) devices 16, and a network interface 18, each interconnected via a bus 20. Processing device 12 may be a general-purpose or specific-purpose processor or microcontroller. Computer system 10 can be configured from multiple devices in multiple locations and, in some implementations, may be part of an enterprise resource planning (“ERP”) system.

In this embodiment, memory device 14 is configured to store, among other things, a talent review module 22. Memory device 14 may include one or more internally fixed storage units, removable storage units, and/or remotely accessible storage units. The storage units can be configured to store information, data, instructions, and/or software code. The storage units may include any combination of volatile memory and/or non-volatile memory.

Memory device 14 can also store program code that enables processing device 12 to execute procedures for enabling one or more users to review and manipulate talent indicators for one or more employees. Various logical instructions or commands may be included in the program code for reviewing and manipulating the talent indicators. The embodiments of talent review modules described in the present disclosure can be implemented in hardware, software, firmware, or a combination thereof. When implemented in software or firmware, talent review module 22 can be stored in memory device 14 and executed by processing device 12. When implemented in hardware, the talent review circuit and systems can be implemented in processing device 12 using discrete logic circuitry, an application specific integrated circuit (ASIC), a programmable gate array (PGA), a field programmable gate array (FPGA), other suitable logic circuit, or any combination thereof.

Talent review module 22 and/or other related talent review circuitry and systems, which can be stored partially or fully in memory device 14, and any other software, programs, or computer code including executable logical instructions as described herein, can be embodied in computer-readable media for execution by any suitable processing device, such as processing device 12. The computer-readable media as described herein can include one or more suitable physical media components that can store the software, programs, or computer code for a measurable length of time.

I/O devices 16 may include input mechanisms such as keyboards, keypads, cursor control devices, or other data entry devices for entering information in memory device 14. I/O devices 16 also include output devices, such as computer monitors, audio output devices, printers, or other peripheral devices for communicating information to a user.

Talent review module 22 is a tool that integrates information about employee profiles, performance, goals, individual development plans, compensation, etc. For example, employee profile information may include the employee name, contact information, job, assignment, location, competencies, licenses, risk of loss, potential, etc. Performance and goal information may include personal evaluations, manager assessments, personal and professional development goals, etc. Compensation information may include salary, bonuses, benefits, etc. The information can be aggregated from various sources via network interface 18 and stored in memory device 14. During use of talent review module 22, some information pertaining to one or more employees may be changed or modified. In this case, talent review module 22 may be configured to automatically update or store the changes in memory device 14 or can change the data stored in the various sources as necessary via network interface 18. When changes are made to the original sources of information, a flag or other type of indication can be stored with the information to indicate that the changes were made during use of talent review module 22.

Talent review module 22 may include any suitable combination of modules to allow one or more users to review and/or manipulate data associated with the talent, performance, potential, etc. of a number of employees. Regarding the embodiments in which multiple users access a particular population set of employees to review, talent review module 22 may be configured to operate in conjunction with other talent review modules of other computers systems linked through an organization's network. In this respect, the multiple users can view and modify the same information in a cooperative fashion. Talent review module 22 can enable the users to analyze a number of employees as desired, analyze potential loss characteristics of the employees, plan succession and/or hierarchical information associated with a number of employees, plan compensation of employees, among other functions. Talent review module 22 can present the talent information to the users in any suitable manner. Specific examples of use and characteristics of talent review module 22 are described in more detail with respect to FIGS. 2-6.

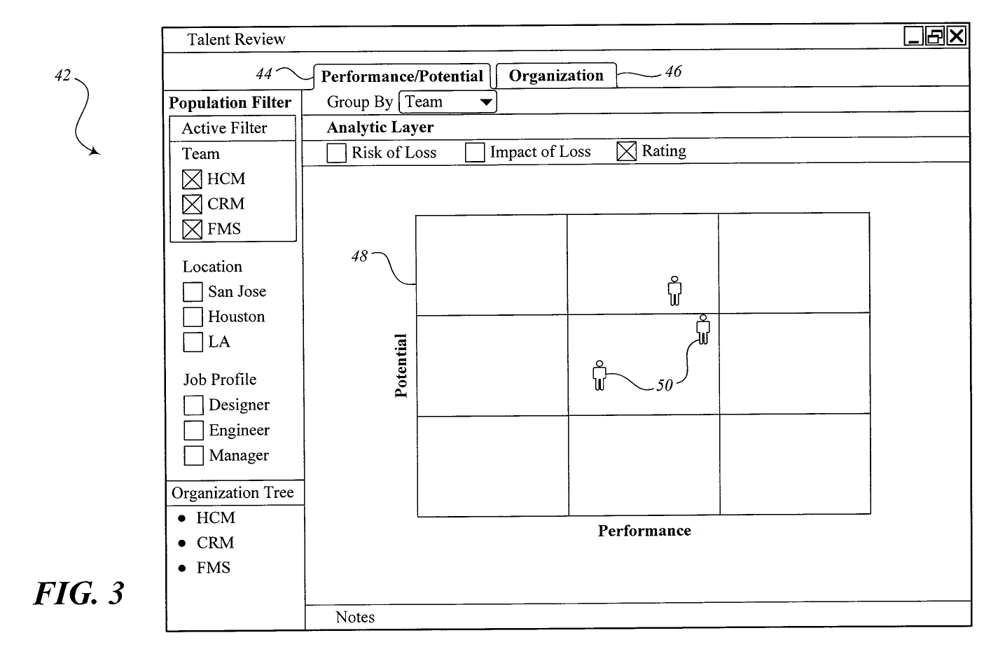

FIG. 2 is a block diagram illustrating an embodiment of talent review module 22 shown in FIG. 1. The modules shown in FIG. 2 may be associated with one or more user interfaces, such as those shown in FIGS. 3-7. In this embodiment, talent review module 22 includes an aggregating module 24, an employee profile module 26, a talent history module 28, a meeting managing module 30, a talent review dashboard module 32, a loss analyzing module 34, a succession planning module 36, and a compensation planning module 38.

Aggregating module 24 is configured to integrate data from multiple sources and store this data in memory. In some embodiments, aggregating module 24 can filter population sets using a progressive model, which allows users to refine a filter applied to the population set in layers. For example, when a location filter is applied, the user can apply the filter based on a country, then a state, then a city, then a facility within that city. Since location hierarchy is defined by the user, each layer can be customized by the user and presented for selection accordingly.

Information gathered by aggregating module 24 may be stored partially or entirely in employee profile module 26. Employee profile module 26 can be configured to store, for example, employee names, competencies, certifications, licenses, potential rating, and other personal information of a number of employees. Also, employee profile module 26 can store, potential rankings, readiness rankings (assessment of an employee's ability to move to the next job level), succession information, likelihood of retention, risk of loss, impact of loss, etc.

Talent history module 28 can be used as an archive to store employee talent information over the employment history of the employees within the organization. Normally, employee profile module 26 is used for current analysis and evaluation, but talent history module 28 can be used to store the same information from previous employee evaluation sessions or reviews. In this way, a user can access the employee's information from previous review cycles to see the progress that the employee has made over time. The information in talent history module 28 is based on multiple periodic review sessions over time. An organization might perform talent reviews with regular periodicity, such as yearly, quarterly, monthly, etc. The frequency of talent reviews that an organization performs determines the amount of talent history information that can be stored for each employee.

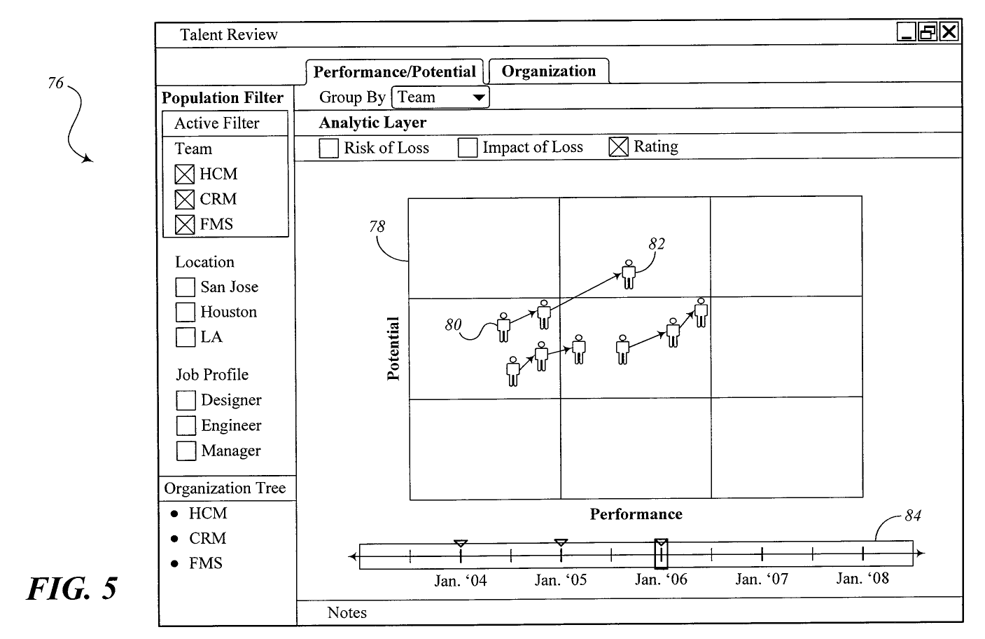

Talent history module 28 is configured to store information about the employees of the organization as well as current and previous data elements representing performance and/or potential ratings of the employees. Any notes that are taken during the talent review meetings can also be stored for future reference. The information may be based on multiple review sessions over time, recorded yearly, quarterly, etc., and may be used to show progress. From the historic information regarding the performance of the employees, talent history module 28 can manipulate this information to present graphic elements showing talent information over time. As shown in FIG. 5, a timeline can be displayed allowing the user to access prior talent review meeting information or other relevant information from previous reviews. The user is able to utilize talent history module 28 to access one or more prior reviews or rankings.

Meeting managing module 30 enables a user to set up talent review meetings for any number of participants, set up a schedule for the meetings, select the participants, etc. For example, if a talent review meeting is to be scheduled for a particular employee or group of employee, the meeting can be scheduled, for example, to include the employee's supervisors or managers, and any other people who may be able to contribute to the meeting. Meeting managing module 30 can also be used to select a population set, which may include, for example, the employees who report to the same manager.

Regarding the talent review meetings, anyone in the organization can set up the meeting and act as the facilitator, unless the organization has certain restrictions in this regard. The person who sets up the meeting can create or select a checklist to be provided to the meeting participants beforehand to allow the participants to prepare information relevant to the meeting. For example, the participants may review organizational trends or areas of risk to help determine each employee's talent, value, goals, etc. Furthermore, the person setting up the meeting can set a deadline for the participants to enter relevant data regarding the employees to be evaluated.

As described in more detail below with respect to FIGS. 3-7, meeting managing module 30 may be associated with any type and number of user interfaces for the actual execution of the meeting. For example, information about the employee or group of employees being reviewed can be presented in a graphical format to better communicate the talent and value of the employees with respect to other employees or groups. By graphically presenting employee information, comparisons can be made with respect to other employees to help managers determine the employees who might be best suited for filling certain positions or jobs if such positions or jobs are left open at a later time. This can help to fill these positions more easily and fairly and can show potential risks should one or more employees leave the organization. Other benefits of the graphical displays will be apparent to one of ordinary skill in the art from an understanding of the present disclosure.

During a talent review meeting, meeting managing module 30 is also capable of tracking the actions that are performed during the meeting. For example, if changes are made to an employee's performance or potential status, then these changes can be stored for later reference.

When scheduling a talent review meeting using meeting managing module 30, the user can enter a title of the meeting for identification. The user can also enter a purpose for the meeting, such as to review and modify performance or potential of employees, to update the goals or development plans, to review compensation, to analyze organization trends and risk areas, to group employees into talent pools, to assign potential successors, etc. The user also lists the participants and the level of access granted to each participant. In addition, the user selects a population group to be reviewed. The population may depend on the participants and the scope of the review. For instance, the population may include a single department, a business unit, employees sharing a similar job profile, location, facility, etc. During set up of the meeting, the user can also use meeting managing module 30 to enter or select the items to be discussed, reviewed, determined, changed, etc., such as, for example, performance rating, potential rating, risk of loss, impact of loss, goals, compensation, progress, etc.

Once the talent review meeting has been set up and scheduled, the participants will have access to a talent review checklist, which lists the issues that are to be brought up during the meeting. This helps the facilitator and participants to ensure that the essential elements for review are entered before the meeting or before a deadline. The participants can also check displays of employees' performance and potential to ensure that these factors are plotted as expected. The checklist can also be used to highlight individuals as needed. Participants can also change rating values for performance and potential, remove employees for review, etc.

During the talent review meeting, meeting managing module 30 enables the facilitator to start the meeting at any time. When the meeting is started, meeting managing module 30 may display a user interface or other suitable presentation showing icons or symbols representing the employees that are in the selected population set. The employee icons can be displayed in a box chart configuration, as is explained in more detail below. The term “box chart” is defined herein as a two-dimensional chart including an array of boxes for somewhat arbitrarily dividing the chart into sections. Points on the chart can be categorized by the box in which the respective points are plotted.

With meeting managing module 30, an action capture feature may be included in meeting managing module 30 that automatically captures the actions taken during the talent review meeting. In this respect, meeting managing module 30 can track the actions, assign the actions to specific participants, and capture any type of useful information regarding the actions taken during the meeting. The actions may include changing compensation of one or more employees, changing a ranking of one or more employees, changing the performance rating of one or more employees, etc. The captures actions may also include behind-the-scenes type actions, such as, for example, accessing of employee information, moving employee icons, grouping employees, ungrouping an employee group, zooming in or out, etc. For actions affecting an employee's status, the actions can have an open ended target date or can have a specific start or completion date. Each action can be defined by a status, e.g., “complete,” “unassigned,” “assigned,” “not started,” “in progress,” “complete,” etc. Once an action is saved, a notification can be automatically sent to the person or persons assigned with the responsibility of completing the action.

Regarding meeting managing module 30, a user is enabled to setup the talent review meeting, where setup includes naming the facilitator, participants, population set, data requirements, etc. Meeting managing module 30 enables the facilitator to initialize the talent review meeting and open up the user interfaces. However, theses features may be disabled for the participants. The participants are allowed to access the talent review meeting and related user interfaces. Also, the participants can be granted access to a Participant Checklist feature, as explained above. They can also enter information that can be used during the talent review meeting.

For the individuals who are not represented in a box chart, talent review dashboard module 32 may be used to enable the facilitator or participants to plot employee icons for the individuals on the box chart. Talent review dashboard module 32 can include any suitable combination of manipulation tools to aid the user in the process of entering, modifying, and/or moving employee icons as needed.

Talent review dashboard module 32 may be configured with a number of filtering features allowing a user to filter or narrow the population set that is being displayed on the box chart. A list of optional filter items can be displayed for the user's selection. In some embodiments, the filter options can be applied progressively, allowing the population set to be reduced in segments. For example, when a “location” filter is used, the user can first select a country, then a region, then a state or province, then a city, then a facility, etc. A non-limiting list of optional filters includes filters for “location,” “organization,” “team,” “job profile,” “years of service,” etc.

Furthermore, talent review dashboard module 32 can be used to group or aggregate a number of employees based on certain grouping or filtering features. For example, specific groups can be selected to represent teams within the organization such as “sales”, “manufacturing”, “management”, “marketing”, etc. With the grouping feature, the average ratings or rankings of all the employees in the group are determined and graphically displayed as a single icon. This can be used to assess group bias due to differences in manager's ranking tendencies or to rank an entire group as a whole. This can also be used to automatically group a number of similarly ranked employees when the total number of employee icons exceeds an acceptable limit, based on a predetermined number of employees, space limitations of the user interface, etc.

Talent review dashboard module 32 can also be configured to enable a user to set highlighting features for highlighting specific individuals within the population set. For example, the employees having a certain job profile can be highlighted from a larger population set for emphasis. Highlighting features may include any combination of color codes, shading, size, animation, etc. to distinguish one or more employees or groups from the entire displayed population set.

With talent review dashboard module 32, the user can view additional information about an employee or group of employees by selecting the employee icon representing the employee or group. For example, the user can use a coordinate control device, e.g., computer mouse, to hover over the icon to automatically bring up the additional information. In other embodiments, the user can use a mouse to click on the icon or use any other suitable selection type mechanism or technique. The additional information presented to the user when a specific icon is selection may include, for instance, information regarding performance, which may include the employee's self evaluation and/or manager's evaluation. The additional information may also include personal records regarding name, address, current jobs or roles, previous experience, competencies, talents, education, etc. The additional information may also include employee goals or development plans, compensation record and/or plans, etc. In some embodiments, the additional information may be associated with data managed by loss analyzing module 34, succession planning module 36, compensation planning module 38, etc.

Talent review dashboard module 32 is configured to enable the user to manage performance and/or potential information for one or more employees. The user can access current or previous performance ratings, change current ratings according to accessible information regarding the employee's status, and other actions. Using talent review dashboard module 32, the user can also create individual development plans, manage talent pools, pool a number of employees into groups for automatically calculating an average of the pool. Also, talent review dashboard module 32 allows the user to configure how the performance or talent information is displayed. For example, if the information is displayed in a box chart, the user can select how the number of boxes in the array. Any suitable array size can be selected, such as, for example, 2×2, 2×3, 3×3, 3×4, 3×5, 4×5, etc.

Talent review dashboard module 32 is also capable of performing statistical analysis on each box of the array. For example, talent review dashboard module 32 can determine the number of employees in each box and the percentages of employees of the population in each box. Talent review dashboard module 32 is able to enable the user to change the employee's position within the box chart during the review meeting. This can be performed, for example, using a drag and drop procedure. Talent review dashboard module 32 can also store performance information and potential information for one or more employees. Also, a talent review rating that is representative of a rating resulting from the talent review meeting can be stored separately from the performance and potential information.

Loss analyzing module 34 is configured to enable the user to analyze an estimation of the risk that an employee may leave the organization. This aspect is referred to herein as “risk of loss.” The risk of loss can be calculated based on a number of factors, such as, for example, years of service, performance ranking, performance versus compensation, etc. Also, loss analyzing module 34 can further indicate the impact that the loss of such an employee would have on the organization, which is referred to herein as “impact of loss.”

Succession planning module 36 is configured to enable the user to identify individuals for certain positions and create a development plan that prepares a successor if one or more particular employees leave the organization. Using succession planning module 36, the user can view the graphic information concerning successor information and the development plan to gain a better understanding of the importance of retaining key employees. Also, based on an analysis of successor information and development plans, the user can use succession planning module 36 to plan a hierarchical plan or structure.

Compensation planning module 38 can be used to plan and/or take into action compensation changes for one or more employees. For example, a participant of the talent review meeting, who has proper authorization, can review the salary, benefits, etc., of an employee or a group of employees within a common group. Positive compensation changes can be done, for instance, to help motivate high value employees

FIG. 3 is a diagram illustrating an embodiment of a user interface 42 enabling a user to review and/or modify performance and potential characteristics of one or more employees. User interface 42 may represent a pool of information for a population set. The user may view user interface 42 to gain an understanding of the composition of the workforce. User interface 42 can be used to plan development interventions, develop workforce, retain and motivate high value employees, and possibly terminate the lower value employees if necessary.

With user interface 42, the user can select a “performance/potential” tab 44 or an “organization” tab 46. Performance/potential tab 44 shows the performance and potential information for one or more employees. The performance and potential rankings can be shown for individuals or can be grouped by team, location, job profile, etc. User interface 42 includes an analytic layer allowing the user to choose a view of “risk of loss,” “impact of loss,” or “rating.” In the example shown, the ratings of the performance and potential are shown. With respect to the embodiment shown in FIG. 3, user interface 42 includes a box chart 48. In other embodiments, graphical information regarding performance or talent can be presented using a distribution chart or bell curve view where groups of employees are categorized into percentages or standard deviations along the length of the distribution or bell curve. In other embodiments, the graphical information can be presented along a linear graph, where employees with higher performance and potential ratings are given a higher rank along the linear graph. These and other graphical representations can be used to illustrate the performance, talent, or value of a number of employees.

Regarding the embodiments in which a box chart, such as the illustrated box chart 48, is used to display information, the chart can include any number of boxes in an array. The user is enabled to configure box chart 48 to include, for example, 2×2, 2×3, 3×3, 3×4, 3×5, 4×5, or other array of boxes. Employee icons 50 are positioned on box chart 48, such that the icons that are positioned further up represent employees with higher potential and those positioned further to the right represent employees with higher performance. Therefore, the higher talent employees are positioned in the upper right box, which can be identified easily as the employees with higher value to the organization. Therefore, user interface 42 can show in general the employees' standing in the organization or at least their standing with respect to the other employees.

Employee icons 50 can represent individuals or a group of individuals, e.g., teams. Icons 50 are data points that can be selected from any population set, such as organization, business unit, location, job, etc. When grouped, the average rankings of the employees in that group are represented by a single employee icon 50. On the left side of user interface 42, a population filter is used to present three teams, e.g., HCM, CRM, and FMS, which represent the organizational divisions within an company, like “sales”, “manufacturing”, “management”, “marketing”, etc. When grouped together, the average for each of the respective teams can be represented by one employee icon 50. To distinguish the teams from each other, employee icons 50 can be given different colors. In addition to color coding, other highlighting features, such as size, brightness, outlines around the icons, etc., can be used for distinction. For identification purposes, a name of the employee, or a name of a group or team of employees, can be positioned near, e.g., directly beneath, the respective employee icon 50.

To see additional information of an employee, the user can select an employee icon 50 by any suitable means. Additional information can be presented in another window, e.g., pop-up window, or in another format. The additional information may include profile information about the employee, such as full name of employee, location, job/position/assignment, risk of loss rating, impact of loss rating, talent pool assignment, successor, etc. Furthermore, the additional information may include performance information, such as performance documents, worker's self-evaluations, manager's evaluation, side-by-side comparison of the employee and manager evaluation for the same performance period, etc. The additional information may also include compensation information, salary history, incentive compensation, bonuses, stock grants, “walk-away value,” comp ratio, etc. Also, the additional information can include goal and development plans, such as performance goals, development goals, personal goals, etc.

In some embodiments, user interface 42 may include an option allowing the user to download information in box chart 48 to a spreadsheet. Also, in some implementations, the information may be printed on a printer.

User interface 42 may further include a notes section, as shown at the bottom of user interface 42. The notes section can be used to store notes that are entered during the talent review meeting. For example, a participant may wish to provide a reason why a specific change in a rating is being made. The notes may also include other topics discussed during the meeting. Also, the notes section may be configured to record action items that are captured to clarify, for example, which participant is assigned with a given task, e.g., creating a development plan. In some embodiments, notes can be taken off-line and attached to a file associated with user interface 42.

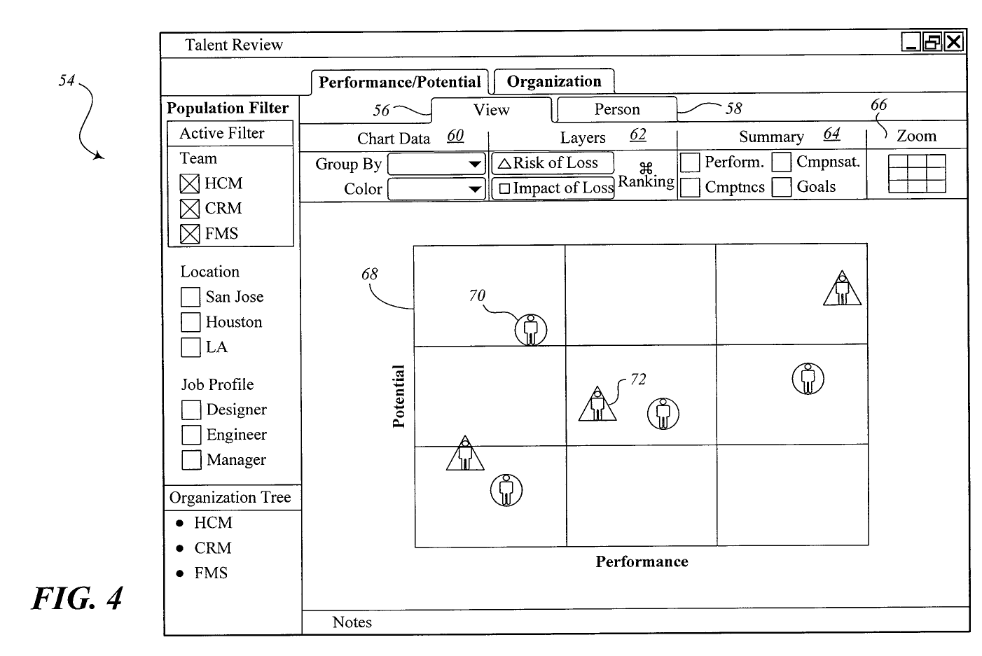

FIG. 4 is a diagram illustrating an embodiment of a user interface 54 enabling a user to review and/or modify characteristics regarding loss or retention of employees. In this embodiment, user interface 54 is configured to manage analytic features, e.g., risk of loss, impact of loss, etc. User interface 54 is this case includes a “view” tab 56 and a “person” tab 58. Under view tab 56, the user can enter, select, or edit information related to various features. For example, this embodiment of user interface 54 includes a “chart data” section 60, a “layers” section 62, a “summary” section 64, and a “zoom” section 66. Using layers section 62, the user can add or modify loss elements related to one or more employees. Any suitable highlighting or coding scheme can be used to help identify different aspects of a box chart 68. In this embodiment, a circle element is used to highlight certain icons 70 and a triangle element is used to highlight other icons 72. The highlighting features can be used to indicate different levels of certain factors, such as risk of loss, impact of loss, etc.

FIG. 5 is a diagram illustrating an embodiment of a user interface 76 enabling a user to review a history of talent characteristics of a number of employees. User interface 76 in this embodiment may be associated with talent history module 28 (FIG. 2) for showing a scale of improvements with respect to performance and potential over time. In box chart 78, a beginning icon 80 is used to show a rating at an initial time for the employee, while an ending icon 82 is used to show a rating at an end time. The beginning time and ending time may represent the first and last evaluations for an employee. However, in other embodiments, the beginning and ending times may represent the progress over any time period. The icons of box chart 78 may be used to illustrate in graphical form the progress that each employee has made over time. In some embodiments, the icons may represent a group of employees to show the progress of the group.

User interface 76 further includes a timeline 84 for showing previous evaluations that are available. Timeline 84 can include any period of time and may end at the latest evaluation period. Also, timeline 84 may be incremented according to the frequency of evaluation times. In this example, three employee icons are shown in box chart 78 to represent an employee's progress over a period of three evaluations. These three evaluations in this example are shown in timeline 84 as the evaluations recorded in January 2004, January 2005, and January 2006. It should be understood, however, that any number of icons may be shown depending on the number of evaluations or talent review meetings that have been recorded and selected.

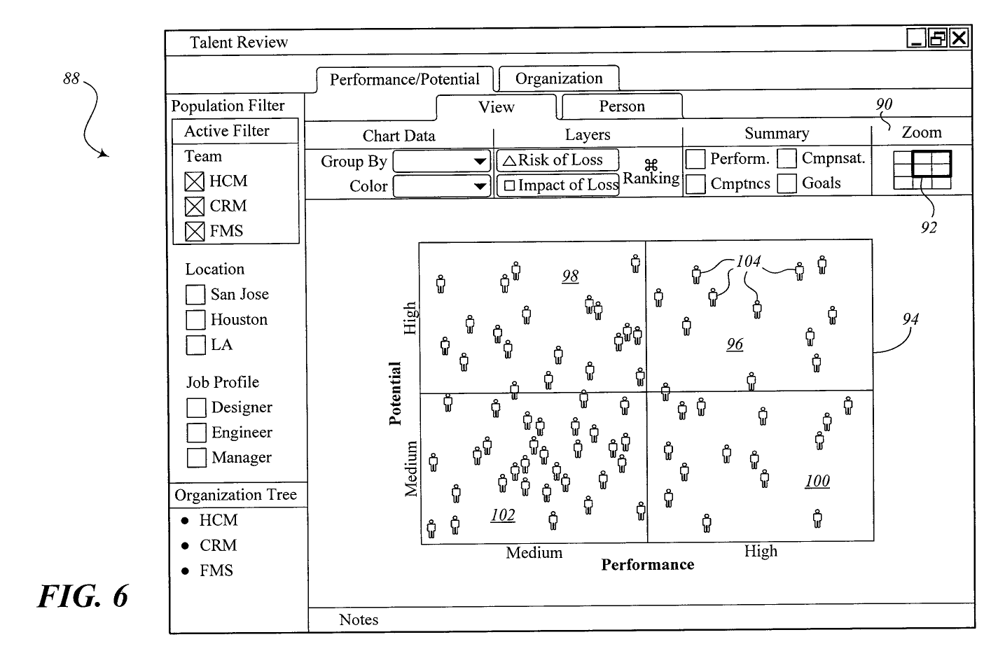

FIG. 6 is a diagram illustrating an embodiment of a user interface 88 enabling a user to review and/or modify performance and potential characteristics of a number of employees. User interface 88 shows the effect of the user manipulating the zoom feature with respect to a zoom section 90. For example, user interface 88 is configured to allow user to select a group of boxes or a single box if desired. By using a zooming chart 92 showing the boxes to be displayed in user interface 88, the user can zoom in to see greater detail in the selected box or boxes. This can be helpful especially with a large population set. Also, it may be easier during the talent review meeting to make decisions based on the respective box or boxes being viewed.

As illustrated in FIG. 6, zooming chart 92 shows that there are nine boxes in the total chart, configured in a 3×3 array. Zooming chart 92 also shows that the four boxes in the upper right hand corner of the array are selected. Box chart 94, in this example, include box 96, box 98, box 100, and box 102. As shown, employee icons 104 are distributed throughout the four boxes. Boxes 96 and 98 represent high potential employees and boxes 100 and 102 represent medium potential employees. Also, boxes 96 and 100 represent high performance and boxes 98 and 102 represent medium performance. Therefore, box 96 in the upper right corner represents the highest value group of employees. It may be desirable, for example, for the user to zoom to box 96 to see this high value group and make decisions regarding bonuses, compensation increases, succession information, etc.

User interface 88 may be used to examine organizational trends with respect to employee talent and can be used to evaluate certain areas of risk. From user interface 88, participants of the talent review meeting can manipulate the employee icons 104 as necessary to rank the employees fairly. Also, new employee icons 104 can be added for employees not already represented. Movement of icons 104 can be made to reflect performance and/or potential evaluation revisions.

In some embodiments, user interface 88 may be configured to display up to a maximum number of employees in order that box chart 94 does not get too crowded. For example, a population set of about 75 to 100 may be a good range. However, it should be understood that any number of employees can be evaluated and represented by employee icons 104. In some instances, a threshold level may be set, either automatically or by the user, to limit the number of employee icons 104. In this respect, user interface 88 may issue a warning if the number of icons 104 is near the threshold. In some implementations, employee icons 104 that have a similar positioning on box chart 94 can be automatically combined into one icon, or superimposed over each other, or overlapped, etc., in order to reduce the total number or overcrowding of icons 104.

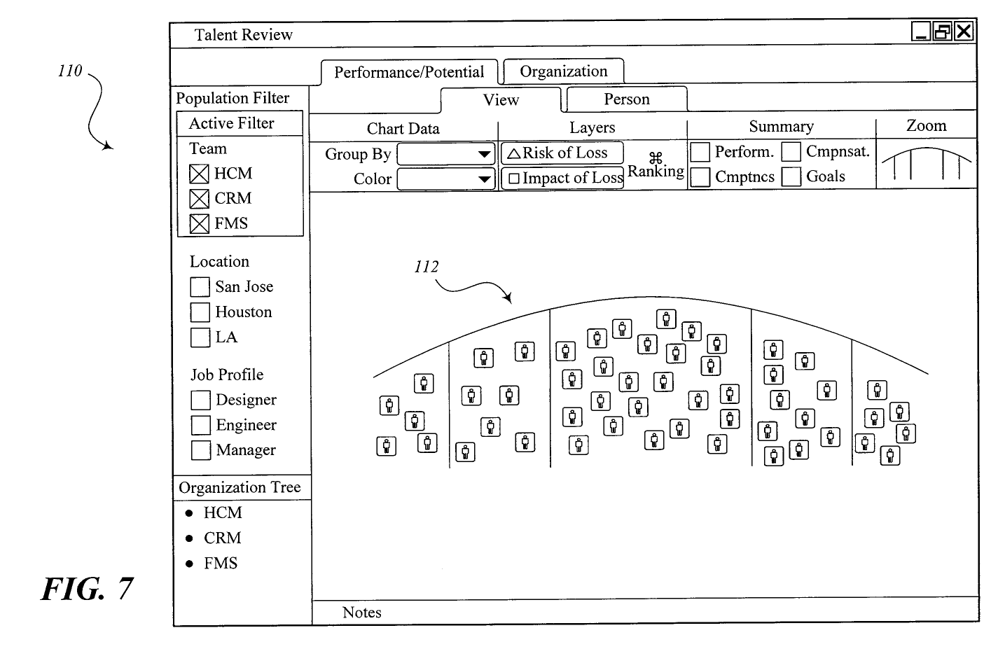

FIG. 7 is a diagram illustrating an embodiment of a user interface 110 enabling a user to review and/or modify performance and potential characteristics of a number of employees. In this embodiment, user interface 110 shows the distribution of employee icons in a bell curve 112. Bell curve 112 includes five divisions for separating the employee icons into groups. The user may use the zoom feature to zoom into one or more divisions as desired. Bell curve 112 can further include a description of each division according to some embodiments. For example, the leftmost division may be labeled “under performing”. The next division may be labeled “below average”, the center division labeled “average”, the next division labeled “above average”, and the far right division “super performing”. Also, percentages can be illustrated next to the respective divisions to show the actual percentages of employees in the respective divisions and also to show a goal percentage for the particular divisions.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A method for reviewing talent, the method comprising:
gathering information from one or more source applications within an organization, the information related to talent characteristics of one or more employees of the organization; and
graphically displaying one or more of the talent characteristics of the one or more employees.

2. The method of claim 1, wherein gathering information further comprises allowing a user a select a population set from a plurality of employees in the organization.

3. The method of claim 1, wherein graphically displaying further comprises utilizing a talent review dashboard module configured to graphically display performance and potential information of the one or more employees.

4. The method of claim 3, further comprising utilizing the talent review dashboard module to display an icon for each of a plurality of employees.

5. The method of claim 3, further comprising utilizing the talent review dashboard module to display an icon for each of a plurality of groups of employees.

6. The method of claim 3, further comprising utilizing the talent review dashboard module to display the performance and potential information on a box chart.

7. The method of claim 3, further comprising utilizing the talent review dashboard module to enable a user to create an individual development plan for one or more employees.

8. The method of claim 1, wherein the method further comprises managing a talent review meeting allowing one or more participants to analyze the one or more talent characteristics of the one or more employees.

9. The method of claim 8, wherein managing the talent review meeting further comprises allowing the participants to change the one or more talent characteristics of one or more employees during the talent review meeting.

10. The method of claim 1, wherein the method further comprises analyzing a risk of losing an employee and analyzing an impact of loss of the employee.

11. The method of claim 1, wherein the method further comprises enabling a user to plan successors for one or more employees.

12. The method of claim 1, wherein the method further comprises enabling a user to analyze compensation information associated with one or more employees.

13. The method of claim 1, wherein the method further comprises storing a history of talent reviews for one or more employees.

14. The method of claim 13, wherein graphically displaying one or more of the talent characteristics of the one or more employees further comprises displaying the history of talent reviews for each of the one or more employees.

15. The method of claim 1, wherein the method comprises instructions stored on a computer-readable medium and executed by a processing device.

16. A computer system comprising:
a network interface in communication with a network associated with an organization, the network interface configured to receive employee information from one or more sources on the network, the employee information being associated with one or more employees of the organization;
a memory device configured to store the employee information;
an output device configured to display performance information related to one or more employees; and
a processing device configured to execute procedures associated with managing talent information regarding one or more employees;
wherein the processing device is further configured to process the employee information to graphically display the performance information on the output device.

17. The computer system of claim 16, wherein the procedures associated with managing talent information are configured as logic instructions stored within computer-readable media.

18. The computer system of claim 16, wherein the procedures associated with managing talent information are configured in hardware in the processing device.

19. A user interface comprising:
a population filter enabling a user to select a pool of one or more employees of an organization to create a population set;
a box chart having a performance axis and a potential axis to graphically display performance and potential information of the population set.

20. The user interface of claim 19, wherein the box chart is configurable to include any number of boxes in an array.

21. The user interface of claim 20, further comprising a zoom feature enabling the user to zoom in to view a fraction of the total number of boxes in the array.

22. The user interface of claim 19, further comprising one or more employee icons positioned on the box chart, each employee icon representing performance and potential information of a respective employee or group of employees.

23. The user interface of claim 22, wherein the employee icons are highlighted for distinction purposes.

24. The user interface of claim 22, wherein the user interface enables the user to modify the position of the employee icons with respect to the box chart.

25. The user interface of claim 19, wherein the user interface is accessible by a number of participants of a talent review meeting.

26. The user interface of claim 25, wherein the user interface enables one or more of the participants to modify the performance and potential information with respect to the box chart.
